(19) United States
(12) Patent Application Publication
(10) Pub. No.: US 2005/0176578 A1
(43) Pub. Date: Aug. 11, 2005

(54) Supported catalyst systems

(76) Inventors: David Reed Neithamer, Midland, MI (US); Kevin Paul Peil, Auburn, MI (US); David Richard Wilson, Midland, MI (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/381,375

(22) PCT Filed: Aug. 21, 2001
(86) PCT No.: PCT/GB01/03751

(51) Int. Cl. B01J 31/00

(52) U.S. Cl. 502/155; 502/150; 502/152; 502/153; 502/154; 502/162; 526/170; 526/901; 526/943

(57) ABSTRACT

A supported catalyst composition useful in the polymerization of addition polymerizable monomers, a method for making and a polymerization process using the same, the composition including: 1) a support, 2) one or more transition metal complexes, 3) one or more, non-ionic Lewis acid activators such as tris(pentafluorophenyl)boron or tris(pentafluorophenyl)aluminum, and 4) one or more non-protic Lewis base modifiers such as diethylether, triethylamine, or triphenylphosphine.

### FIELD OF THE INVENTION

This invention relates to supported catalysts that are useful for the polymerization of addition polymerizable monomers. More particularly, the invention relates to supported catalysts comprising a support, one or more transition metal complexes, a Lewis acid activator and a modifier. The invention also relates to the use of such supported catalysts n the polymerization of addition polymerizable monomers, especially in an olefin polymerization process.

### BACKGROUND OF THE INVENTION

Several supported catalysts for use in olefin polymerization processes have been previously disclosed in the art. WO-91/09882 describes a supported catalyst prepared by combining i) a bis(cyclopentadienyl) metal compound containing at least one ligand capable of reacting with a proton, ii) an activator component comprising a cation capable of donating a proton and a bulky, labile anion capable of stabilizing the metal cation formed as a result of reaction between the metal compound and the activator component, and iii) a catalyst support material. The support material can be subjected to a thermal or chemical dehydration treatment. In some of the examples, triethyl aluminum is added for this purpose. The maximum bulk density of polymers formed by use of the foregoing supported catalyst reported in WO 91/09882 is 0.17 g/cm³. The reported catalyst efficiencies are less than satisfactory for commercial applications.

WO-94/03506 describes a supported ionic catalyst prepared by combining (i) a monocyclopentadienyl metal compound, (ii) an activator component comprising a cation which will irreversibly react with at least one ligand contained in said metal compound and an anion, said anion being a chemically stable, non-nucleophilic, anionic complex, and (iii) a catalyst support material. Optionally, the supported ionic catalyst can be prepolymerized with an olefinic monomer. The support material can also be treated with a hydrolyzable organoadditive, preferably a Group 13 alkyl compound such as triethylaluminum. The reference also teaches the use of such supported ionic catalysts in a gas phase polymerization process. Disadvantageously, the catalyst efficiencies obtained in WO-94/03506, are likewise insufficient for commercial use.

U.S. Pat. No. 5,807,938 discloses catalysts obtainable by contacting a Group 4 transition metal compound, an organometallic compound, and a solid catalyst component comprising a carrier and an ionized ionic compound capable of activating the Group 4 transition metal compound, wherein the ionized ionic compound has a cationic component fixed to the surface of the carrier, and an anionic component. The reported process for preparing the catalyst system will generate inorganic salts which may be difficult to remove.

U.S. Pat. No. 5,721,183 discloses addition polymerization catalysts comprising Group 4 metal complexes and adducts of tris(organyl)borane compounds with a non-tertiary amine or non-tertiary phosphine compounds. U.S. Pat. No. 5,296,433 discloses the use of tris(pentafluorophenyl)borane complexed with a compound such as water, alcohols, mercaptans. silanols and oximes as a catalyst activator for transition metal complexes in the polymerization of olefins. WO 99/64476 discloses the preparation of polyolefins through polymerization of olefins with a catalyst formed from a transition metal complex and a Lewis acid-base complex, where the Lewis acid group is an aluminum or boron compound having at least one halogenated aryl ligand and the Lewis base group is an amine or ether compound, the combination being conducted in the presence of a tri-n-alkyl aluminum.

It would be desirable to provide a supported catalyst and a polymerization process using the same that is capable of producing olefin polymers at good catalyst efficiencies. It would further be desirable to provide such a supported catalyst that is adapted for use in a slurry or gas phase polymerization process and is relatively unaffected by the presence of condensed monomer or diluents. It would furthermore be desirable to provide supported catalysts, which exhibit sustained-uniform polymerization rates that allow for greater control over the polymerization.

### SUMMARY OF THE INVENTION

The present invention provides an improved supported catalyst composition comprising: 1) a support, 2) one or more transition metal complexes, 3) one or more non-ionic Lewis acid activators, and 4) one or more non-protic Lewis base modifiers.

In addition, there is provided according to the present invention a method of manufacturing the foregoing supported catalyst composition comprising the steps of combining the foregoing support, one or more transition metal complexes, one or more Lewis acid activators, and one or more non-protic Lewis base modifiers in any order or combination, to thereby prepare a supported catalyst composition useful for polymerization of addition polymerizable monomers.

Finally, the present invention provides a process for polymerization of addition polymerizable monomers, especially an olefin polymerization process, most especially a gas-phase olefin polymerization process, using the foregoing supported catalyst composition or a composition prepared according to the foregoing method.

The present invention is based on the discovery that the non-protic Lewis modifier has a positive effect upon interaction with the Lewis acid activator, or with the combination resulting from interaction of the activator and the transition metal complex. In particular, under gas-phase polymerization conditions, the present supported catalysts demonstrate a reduced initial polymerization rate, such as to decrease localized overheating and loss of polymerization activity. Accordingly, the resulting supported catalysts have desirable long catalyst lifetimes and good productivity.

### DETAILED DESCRIPTION OF THE INVENTION

All references herein to elements or metals belonging to a certain Group refer to the Periodic Table of the Elements published and copyrighted by CRC Press, Inc. 1999. Also any reference to the Group or Groups shall be to the Group or Groups as reflected in this Periodic Table of the Elements using the IUPAC system for numbering groups.

Suitable supports for use as component 1) herein preferably include solid particulated materials that are inert to detrimental reactions that would interfere with the desired formation of a supported catalyst or its use in a polymerization process. Examples include, inorganic oxides, borides, or carbides, and solid hydrocarbon, or silicone polymers. Preferred supports include silicas, aluminas, aluminosilicates, aluminophosphates, clays, titanias, and mixtures thereof. Preferred support materials are inorganic oxides, such as alumina and silica. The most preferred support material is silica. The support material may be in granular, agglomerated, pelletized, or any other physical form.

More preferably, the support has been treated by one or more physical or chemical techniques to reduce the level of reactive substances thereon that would interfere with subsequent reactions desired to occur during formation or use of the supported catalysts, or in order to provide desirable functionality on the catalyst support. Supports that have been physically treated, such as thermally dehydrated especially under reduced pressure or under an inert atmosphere, are referred to herein as “treated supports”. Supports that have been chemically modified are referred to herein as “functionalized supports”.

Most preferred support materials used as component 1) include treated and functionalized inorganic oxides, especially treated and functionalized oxides of silicon and aluminum. Most highly preferably the support material is silica that has been treated by thermal dehydration and functionalized by reaction with one or more organometal or organometalloid compounds.

Support materials for the present invention preferably have a surface area as determined by nitrogen porosimetry using the B.E.T. method from 10 to 1000 m²/g, and preferably from 100 to 600 m²/g. The pore volume, as determined by nitrogen adsorption, advantageously is between 0.1 and 3 cm³/g, preferably from 0.2 to 2 cm³/g. The average particle size depends upon the application, and is typically from 0.5 to 500 μm, preferably from 1-150 μm.

Preferred thermal dehydration treatments (calcining) are carried out at a temperature from 150 to 900° C., preferably 200 to 850° C., for 10 minutes to 50 hours. After thermal dehydration, residual hydroxyl groups may remain on the inorganic oxide. Desirably at least a portion of the residual hydroxyl groups are functionalized by reaction with one or more of the foregoing chemical functionalizing agents, so as to yield a level of residual hydroxyl groups of from 0.0001 to 10, preferably less than 1.0, more preferably less than 0.5 and most preferably less than 0.1 mmol/g. The level of residual hydroxyl functionality can be determined by the technique of Fourier Transform Infrared Spectroscopy (DRIFTS IR) as disclosed in Fourier Transform Infrared Spectroscopy. P. Griffiths & J. de Haseth, 83 Chemical Analysis, Wiley Interscience (1986), p. 544.

Functionalizing agents employed in the practice of the claimed invention preferably have at least one ligand capable of reacting with hydroxyl groups or other reactive functionality of the support material. Preferred functionalizing agents include metal hydrocarbyls in which the metal is selected from Groups 2 and 13 to 16 of the Periodic Table of Elements (preferably aluminum or magnesium), with trialkyl aluminum compounds, such as triethylaluminum, and triisobutyl aluminum being especially preferred.

In a preferred embodiment the functionalizing agent and the inorganic oxide are contacted in the presence of a hydrocarbon diluent. The reaction is conducted at a temperature from 0 to 110° C., preferably from 20 to 50° C. Generally a stoichiometric equivalent or an excess of functionalizing agent, based on residual hydroxyl functionality, is employed. Preferred ratios of functionalizing agent to residual hydroxyl functionality are from 1:1 to 1.5:1. Total amounts of functionalizing agent used per gram of inorganic oxide material are from 1 to 250 mmol/g. As a result of the foregoing functionalizing reaction, residual hydroxyl functionality of the inorganic oxide, if not already low enough is reduced to the previously mentioned low level. Unreacted functionalizing agent is preferably removed from the surface of the support, for example, by washing with a liquid hydrocarbon. Preferably, the support is thoroughly dried prior to use in preparing supported catalyst systems.

The transition metal complexes for use herein comprise one or more Group 3-10 or Lanthanide metals and one or more organic ligand groups. Preferred metal complexes are those comprising a ligand group bonded to the metal by means of delocalized electrons, preferably delocalized it-electrons, and a Group 4 metal.

Suitable metal complexes for use in combination with the foregoing cocatalysts include any complex of a metal of Groups 3-10 of the Periodic Table of the Elements capable of being activated to polymerize addition polymerizable compounds, especially olefins by the present activators. Examples include Group 10 diimine derivatives corresponding to the formula: 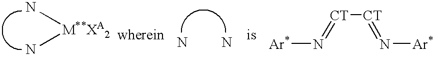
M** is Ni(II) or Pd(H);
X^{A} is halo, hydrocarbyl, or hydrocarbyloxy;
Ar* is an aryl group, especially 2,6-diisopropylphenyl or phenyl; and
CT-CT is I, 2-ethanediyl, 2.3-butanediyl, or forms a fused ring system wherein the two T groups together are a 1,8-naphthanediyl group.

Similar complexes to the foregoing are disclosed by M. Brookhart. et al., in J. Am. Chem. Soc., .118, 267-268 (1996) and J. Am. Chem. Soc., 117, 6414-6415 (1995), as being suitable for forming active polymerization catalysts especially for polymerization of α-olefins, either alone or in combination with polar comonomers such as vinyl chloride, alkyl acrylates and alkyl methacrylates.

Additional complexes include derivatives of Group 3, 4, or Lanthanide metals containing from 1 to 3 π-bonded anionic ligand groups, which may be cyclic or non-cyclic delocalized π-bonded anionic ligand groups. Exemplary of such it-bonded anionic ligand groups are conjugated or nonconjugated, cyclic or non-cyclic dienyl groups, allyl groups, boratabenzene groups and phosphole groups. By the term “π-bonded” is meant that the ligand group is bonded to the transition metal by a sharing of electrons from a delocalized π-bond.

Each atom in the delocalized it-bonded group may independently be substituted with a radical selected from the group consisting of hydrogen, halogen, hydrocarbyl, halohydrocarbyl, hydrocarbyloxy, hydrocarbylsulfide, trihydrocarbylsiloxy, dihydrocarbylamino, and hydrocarbyl-substituted metalloid radicals wherein the metalloid is selected from Group 14 of the Periodic Table of the Elements, and such hydrocarbyl-, halohydrocarbyl-, hydrocarbyloxy-, hydrocarbylsulfide-, trihydrocarbylsiloxy-, dihydrocarbylamino- or hydrocarbyl-substituted metalloid-radicals that are further substituted with a Group 15 or 16 hetero atom containing moiety. Included within the term ‘hydrocarbyl” are C₁₋₂₀ straight, branched and cyclic alkyl radicals, C₆₋₂₀ aromatic radicals, C₇₋₂₀ alkyl substituted aromatic radicals, and C₇₋₂₀ aryl-substituted alkyl radicals. In addition two or more such radicals may together form a fused ring system, including partially or fully hydrogenated fused ring systems, or they may form a metallocycle with the metal. Suitable hydrocarbyl-substituted organometalloid radicals include mono-, di- and tri-substituted organometalloid radicals of Group 14 elements wherein each of the hydrocarbyl groups contains from 1 to 20 carbon atoms. Examples of suitable hydrocarbyl-substituted organometalloid radicals include trimethylsilyl, triethylsilyl, ethyldimethylsilyl, methyldiethylsilyl, triphenylgermyl, and trimethylgermyl groups. Examples of Group 15 or 16 heteroatom-containing moieties include amine, phosphine, ether or thioether moieties or divalent derivatives thereof, for example amide, phosphide, ether or thioether groups bonded to the transition metal or Lanthanide metal, and bonded to the hydrocarbyl group or to the hydrocarbyl-substituted metalloid containing group.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cydohexadienyl, dihydroanthracenyl, hexahydroanthracenyl, decahydroanthracenyl groups, phosphole, and boratabenzene groups, as well as C₁₋₁₀ hydrocarbyl-substituted, C₁₋₁₀ hydrocarbyloxy-substituted, di(C₁₋₁₀ hydrocarbyl)amino-substituted, tri(C₁₋₁₀ hydrocarbyl)siloxy or tri(C₁₋₁₀ hydrocarbyl)silyl-substituted derivatives thereof. Preferred anionic delocalized π-bonded groups are cyclopentadienyl, pentamethylcyclopentadienyl, tetramethylcyclopentadienyl, trimethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, and tetrahydroindenyl.

The boratabenzenes are anionic ligands which are boron containing analogues to benzene. They are previously known in the art having been described by G. Herberich, et al., in Organometallics, 1995, 14, 1,471-480. Preferred boratabenzenes correspond to the formula: 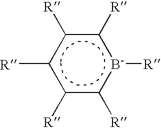
wherein R″ is selected from the group consisting of hydrocarbyl, silyl, or germyl, said R″ having up to 20 non-hydrogen atoms. In complexes involving divalent derivatives of such delocalized π-bonded groups, one atom thereof is bonded by means of a covalent bond or a covalently bonded divalent group to another atom of the complex thereby forming a bridged system.

Phospholes are anionic ligands that are phosphorus-containing analogues to a cyclopentadienyl group. They are previously known in the art having been described by WO 98/50392, and elsewhere. Preferred phosphole ligands correspond to the formula: 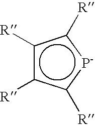
wherein R″ is as previously defined.

Suitable metal complexes for use in the catalysts of the present invention may be derivatives of any transition metal including Lanthanides, but preferably of Group 3, 4, or Lanthanide metals which are in the +2, +3, or ±4 formal oxidation state meeting the previously mentioned requirements. Preferred compounds include metal complexes (metallocenes) containing from 1 to 3 π-bonded anionic ligand groups, which may be cyclic or noncycHc delocalized it-bonded anionic ligand groups. Exemplary of such π-bonded anionic ligand groups are conjugated or nonconjugated, cyclic or non-cyclic dienyl groups, and allyl groups. By the term “π-bonded’ is meant that the ligand group is bonded to the transition metal by means of delocalized electrons present in a π-bond.

More preferred are metal complexes corresponding to the formula:
L*ⱼM′X′ₘX″ₚX′″_{q}, or a dimer thereof
wherein:

L* is an anionic, delocalized, π-bonded group that is bound to M′, containing up to 50 atoms not counting hydrogen, optionally two L* groups may be joined together through one or more substituents thereby forming a bridged structure, and further optionally one L* may be bound to X′ through one or more substituents of L*;

M′ is a metal of Group 4 of the Periodic Table of the Elements in the +2, +3 or +4 formal oxidation state;

X′ is a divalent substituent of up to 50 non-hydrogen atoms that together with L* forms a metallocycle with M′;

X″ is a neutral Lewis base having up to 20 non-hydrogen atoms;

X′″ is independently at each occurrence a monovalent, anionic moiety having up to 40 non-hydrogen atoms, optionally, two X′″ groups may be covalently bound together forming a divalent dianionic moiety having both valences bound to M′, or form a neutral, conjugated or nonconjugated diene that is π-bonded to M′ (whereupon M′ is in the +2 oxidation state), or further optionally one or more X′″ and one or more X″ groups may be bonded together thereby forming a moiety that is both covalently bound to M′ and coordinated thereto by means of Lewis base functionality;

is 1 or 2;

m is 0 or 1;

p is a number from 0 to 3;

q is an integer from 0 to 3; and

the sum, 1+m+q, is equal to the formal oxidation state of M′ except when X′″ groups form a neutral, conjugated or nonconjugated diene that is π-bonded to M′ (whereupon M′ is in the +2 oxidation state).

Such preferred complexes include those containing either one or two L* groups. The latter complexes include those containing a bridging group linking the two L* groups. Preferred bridging groups are those corresponding to the formula (E*R*₂)x wherein E* is silicon or carbon, R* independently each occurrence is hydrogen or a group selected from silyl, hydrocarbyl, hydrocarbyloxy and combinations thereof, said R* having up to 30 carbon or silicon atoms, and x is 1 to 8. Preferably, R* independently each occurrence is methyl, benzyl, tert-butyl, tolyl or phenyl.

Preferred divalent X′ substituents preferably include groups containing up to 30 atoms not counting hydrogen and comprising at east one atom that is oxygen, sulfur, boron or a member of Group 14 of the Periodic Table of the Elements directly attached to the delocalized i-bonded group, and a different atom, selected from the group consisting of nitrogen, phosphorus, oxygen or sulfur that is covalently bonded to M′.

Examples of the foregoing bis(L*) containing complexes are compounds corresponding to the formulas: 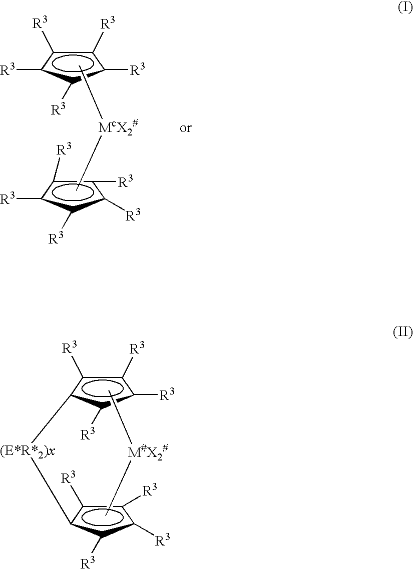
wherein:

M# is titanium. zirconium or hafnium, preferably zirconium or hafnium, in the +2 or +4 formal oxidation state;

R³ in each occurrence independently is selected from the group consisting of hydrogen, hydrocarbyl, dihydrocarbylamino, hydrocarbyleneamino, silyl, trihydrocarbylsiloxy, hydrocarbyloxy, germyl, cyano, halo and combinations thereof, said R³ having up to 20 atoms not counting hydrogen, or adjacent R³ groups together form a divalent derivative thereby forming a fused ring system, and

X^{#} independently at each occurrence is an anionic ligand group of up to 40 atoms not counting hydrogen, or two X^{#} groups together form a divalent anionic ligand group of up to 40 atoms not counting hydrogen or together are a conjugated diene having from 4 to 30 atoms not counting hydrogen forming a π-complex with M^{#}, whereupon M^{#} is in the +2 formal oxidation state, and

(E*R*2)ₓ is as defined above.

The foregoing metal complexes are especially suited for the preparation of polymers having stereoregular molecular structure. In such capacity it is preferred that the complex possess C₂ symmetry or possess a chiral, stereorigid structure. Examples of the first type are compounds possessing different delocalized π-bonded systems, such as one cyclopentadienyl group and one fluorenyl group. Similar systems based on Ti(IV) or Zr(IV) were disclosed for preparation of syndiotactic olefin polymers in Ewen, et al., J. Am. Chem. Soc., 110, 6255-6256 (1980). Examples of chiral structures include bis-indenyl complexes. Similar systems based on Ti(IV) or Zr(IV) were disclosed for preparation of isotactic olefin polymers in Wild et al., J. Organomet. Chem, 232, 233-47, (1982).

Exemplary bridged ligands containing two π-bonded groups are: (dimethylsilyl-bis-cyclopentadienyl), (dimethylsilyl-bis-methylcyclopentadienyl), (dimethylsilyl-bis-ethylcyclopentadienyl), (dimethylsilyl-bis-t-butylcyclopentadienyl), (dimethylsilyl-bis-tetramethylcyclopentadienyl), (dimethylsilyl-bis-indenyl), (dimethylsilyl-bis-tetrahydroindenyl), (dimethylsilyl-bis-fluorenyl), (dimethylsilyl-bis-tetrahydrofluorenyl), (dimethylsilyl-bis-2-methyl-4-phenylindenyl), (dimethylsilyl-bis-2-methylindenyl), (dimethylsilyl-cyclopentadienyl-fluorenyl), (1,1,2,2-tetramethyl-1,2-disilyl-bis-cyclopentadienyl), (1,2-bis(cyclopentadienyl)ethane, and (isopropylidene-cyclopentadienyl-fluorenyl).

Preferred X^{#} groups are selected from hydride, hydrocarbyl, silyl, germyl, halohydrocarbyl, halosilyl, silylhydrocarbyl and aminohydrocarbyl groups, or two X^{#} groups together form a divalent derivative of a conjugated diene or else together they form a neutral, π-bonded, conjugated diene. Most preferred X^{#} groups are C₁₋₂₀ hydrocarbyl groups.

A preferred class of such Group 4 metal coordination complexes used according to the present invention corresponds to the formula: 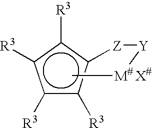
wherein:

M^{#}, X^{#} and R³ are as defined above,

Y is —O—, —S— —NR*, —PR*— and

Z is SIR*₂, CR*₂, SiR*₂SiR*₂, CR*₂CR*₂, CR*═CR*, CR*₂SiR*₂, BNR*₂, or GeR*₂, wherein R* is as defined above.

Illustrative Group 4 metal complexes that may be employed in the practice of the present invention include:
cyclopentadienyltitaniumtrimethyl,
cyclopentadienyltitaniumtriethyl, cyclopentadienyltitaniumtriisopropyl,
cyclopentadienyltitaniumtriphenyl, cyclopentadienyltitaniumtribenzyl,
cyclopentadienyltitanium-2,4-dimethylpentadienyl,
cyclopentadienyltitaniumdimethylmethoxide,
cyclopentadienyltitaniumdimethylchloride,
pentamethylcyclopentadienyltitaniumtrimethyl, indenyltitaniumtrimethyl,
indenyltitaniumtriethyl, indenyltitaniumtripropyl, indenyltitaniumtriphenyl,
tetrahydroindenyltitaniumtribenzyl, pentamethylcyclopentadienyltitaniumtriisopropyl,
pentamethylcyclopentadienyltitaniumtribenzyl,
pentamethylcyclopentadienyltitaniumdimethylmethoxide, (η⁵-2,4-dimethyl-1,3-pentadienyl)titaniumtrimethyl, octahydrofluorenyltitaniumtrimethyl,
tetrahydroindenyltitaniumtrimethyl,
tetrahydrofluorenyltitaniumtrimethyl,
(1,1-dimethyl-2,3,4,9,10-(-1,4,5,6,7,8-hexahydronaphthalenyl)titaniumtrimethyl,
(1,1,2,3-tetramethyl-2,3,4,9,10-(-1,4,5.6,7,8-hexahydronaphthalenyl)titaniumtrimethyl,
(tert-butylamido)(tetramethyl-η⁵-cyclopentadienyl)dimethylsilanetitanium dimethyl,
(tert-butylamido)(tetramethyl-η⁵-cyclopentadienyl)-1,2-ethanediyltitanium dimethyl,
(tert-butylamido)(hexamethyl-η⁵-indenyl)dimethylsilanetitanium dimethyl, (tert-butylamido)(tetramethyl-η⁵-cyclopentadienyl)dimethylsilane titanium (III) 2-(dimethylamino)benzyl;
(tert-butylamido)(tetramethyl-η⁵-cyclopentadienyl)dimethylsilanetitanium (III) allyl,
(tert-butylamido)(tetramethyl-η⁵-cyclopentadienyl)dimethylsilanetitanium (II) (1,4-diphenyl-1,3-butadiene,
(tert-butylamido)(2-methylindenyl)dimethylsilanetitanium (II) 1,4-diphenyl-1,3-butadiene,
(tert-butylamido)(2-methylindenyl)dimethylsilanetitanium (IV) 1,3-butadiene,
(tert-butylamido)(2,3-dimethylindenyl)dimethylsilanetitanium (II) 1,4-diphenyl-1,3-butadiene,
(tert-butylamido)(2,3-dimethylindenyl)dimethylsilanetitanium (IV) 1,3-butadiene,
(tert-butylamido)(2,3-dimethylindenyl)dimethylsilanetitanium (II) 1,3-pentadiene,
(tert-butylamido)(2-methylindenyl)dimethylsilanetitanium (II) 1,3-pentadiene, (tert-butylamido)(2-methylindenyl)dimethylsilanetitanium (IV) dimethyl, (tert-butylamido)(2-methyl-4-phenylindenyl)dimethylsilanetitanium (II) 1,4-diphenyl-1,3-butadiene,
(tert-butylamido)(tetramethyl-η⁵-cyclopentadienyl)dimethylsilanetitanium (IV) 1,3-butadiene,
(tert-butylamido)(tetramethyl-η⁵-cyclopentadienyl)dimethylsilanetitanium (II) 1,4-diphenyl-1,3-butadiene,
(tert-butylamido)(tetramethyl-η⁵-cyclopentadienyl)dimethylsilanetitanium (II) 2,4-hexadiene,
1 5 (tert-butylamido)(tetramethyl-η⁵-cyclopentadienyl)dimethylsilanetitanium (II) 3-methyl 1,3-pentadiene,
(tert-butylamido)(4,4-dimethyl-1-cyclohexadienyl)dimethylsilanetitaniumdimethyl,
(tert-butylamido)(1,1-dimethyl-2,3,4.9,10-(1,4,5,6,7,8-hexahydronaphthalen-4-yl) dimethylsilanetitaniumdimethyl,
(tert-butylamido)(1,1,2,3-tetramethyl-2,3,4,9,10-(π-1,4,5,6,7,8-hexahydronaphthalen-4-yl) dimethylsilanetitaniumdimethyl, (tert-butylamido)(tetramethylcyclopentadienyl)dimethylsilanetitanium 1,3-pentadiene, (tert-butylamido)(3-(N-pyrrolidinyl)inden-1-yl)dimethylsilanetitanium 1,3-pentadiene. (tert-butylamido)(2-methyl-s-indacen-1-yl)dimethylsilanetitanium 1,3-pentadiene, and (tert-butylamido)(3,4-cyclopentaphenanthren-2-yl)dimethylsilanetitanium 1,4-diphenyl-1,3-butadiene.

While the above-recited list of illustrative metal compound, for simplicity, recites the use of titanium, this illustrative listing further includes all corresponding embodiments wherein the metal is any other Group 4 metal. In addition, other metal compounds that are useful in the preparation of the supported catalyst compositions according to this invention, especially compounds containing other Group 4 metals, will be apparent to those skilled in the art.

Bis(L*)containing complexes including bridged complexes suitable for use n the present invention include:
biscyclopentadienylzirconiumdimethyl,
biscyclopentadienylzirconiumdiethyl,
biscyclopentadienylzirconiumdiisopropyl,
biscyclopentadienylzirconiumdiphenyl,
biscycbpentadienylzirconium dibenzyl,
biscyclopentadienylzirconium-diallyl,
biscyclopentadienylzirconiummethylmethoxide,
bispentamethylcyclopentadienylzirconiumdimethyl,
bisindenylzirconiumdimethyl,
indenylfluorenylzirconiumdiethyl,
bisindenylzirconiummethyl(2-(dimethylamino)benzyl),
bisindenylzirconium methyltrimethylsilyl,
bistetrahydroindenylzirconium bis(trimethylsilylmethyl),
bispentamethylcyclopentadienylzirconiumdiisopropyl,
bispentamethylcyclopentadienylzirconiumdibenzyl,
bispentamethylcyclopentadienylzirconiummethylmethoxide
(dimethylsilyl-bis-cyclopentadienyl)zirconiumdimethyl,
(dimethylsilyl-bis-tetramethylcyclopentadienyl)zirconiumdiallyl,
(methylene-bis-tetramethylcyclopentadienyl)zirconium bis(2-(dimethylamino)benzyl),
(dimethylsilyl-bis-2-methylindenyl)zirconiumdimethyl,
(dimethylsilyl-bis-2-methyl-4-phenylindenyl)zirconiumdimethyl,
(dimethylsilyl-bis-2-methylindenyl)zirconium-1,4-diphenyl-1,3-butadiene,(dimethylsilyl-bis-2-methyl-4-phenylindenyt)zirconium (II) 1,4-diphenyl-1,3-butadiene,
(dimethylsilyl-bis-tetrahydroindenyl)zirconium(II) 1,4-diphenyl-1,3-butadiene,
(dimethylsilyl-bis-tetrahydrofluorenyl)zirconium bis(trimethylsilylmethyl),
(isopropylidene)(cyclopentadienyl)(fluorenyl)zirconiumdibenzyl, and
(dimethylsilyltetramethylcyclopentadienylfluorenyl)zirconiumdimethyl.

While the above-recited list of illustrative metal compound, for simplicity, recites the use of zirconium or hafnium, this illustrative listing further includes all corresponding embodiments wherein the metal s any other Group 4 metal. In addition, other metal compounds that are useful in the preparation of the supported catalyst compositions according to this invention, especially compounds containing other Group 4 metals, will be apparent to those skilled in the art.

Other metal compounds that are useful in the preparation of the supported catalyst compositions according to this invention, especially compounds containing other Group 4 metals, will be apparent to those skilled in the art.

The non-ionic Lewis acid activator employed as component 3) in the present invention preferably corresponds to the formula or includes one or more compounds corresponding to the formula:
{M¹ₙ(K)ₖ],

wherein M¹ is boron or aluminum;

K is an anionic ligand group; and

n and k are chosen to provide charge balance.

More preferably, K is a halogenated aromatic ligand of up to 40 atoms, not counting hydrogen. Most preferred non-ionic Lewis acids are tri(fluoroaryl)aluminum or tri(fluoroaryl)boron compounds, most preferably tris(pentafluorophenyl)aluminum or tris(pentafluorophenyl)boron, as well as mixtures or adducts of such tri(fluoroaryl)aluminum compounds or tri(fluoroaryl)boron with one or more trialkylaluminum, alkylaluminumoxy, fluoroarylaluminoxy, or tri(alkyl)boron compounds containing from 1 to 30 carbons in each alkyl group and from 6 to 30 carbons in each fluoroaryl ligand group.

Examples of the foregoing mixtures or adducts of non-ionic, Lewis acids for use herein include compositions corresponding to the formula:
[(—AlQ′-O—)_{z}(—AlAr^{f}-O—)_{z′}](Ar^{f}_{z″}Al₂Q¹_{6-z″}) formula (I)
where;

Q¹ independently each occurrence is selected from hydrocarbyl, hydrocarbyloxy, or dihydrocarbylamido, of from 1 to 30 atoms other than hydrogen;

Ar¹ is a fluorinated aromatic hydrocarbyl moiety of from 6 to 30 carbon atoms;

z is a number from 1 to 50, preferably from 1.5 to 40, more preferably from 2 to 30, and the moiety (—AlQ¹-O—) is a cyclic or linear oligomer with a repeat unit of 2 to 30;

z′ is a number from 1 to 50, preferably from 1.5 to 40, more preferably from 2 to 30, and the moiety (—AlQ¹-O—) is a cyclic or linear oligomer with a repeat unit of 2 to 30; and

z″ is a number from 0 to 6, and the moiety (Ar^{f}_{z″}Al₂Q¹_{6-z″}) is either tri(fluoroarylaluminum), trialkyaluminum, a dialkylaluminumalkoxide, a dialkylaluminum(dialkylamide) or an adduct of tri(fluoroarylaluminum) with a sub-stoichiometric to super-stoichiometric amount of a trialkylaluminum.

The moieties (Ar^{f}_{z″}Al₂Q¹_{6-z″})) may exist as discrete entities or dynamic exchange products. That is, such moieties may be in the form of dimeric or other multiple centered products. and may exist in combination with additional metal complexes thereby resulting in partial or complete ligand exchange products. Such exchange products may be fluxional in nature, the concentration thereof being dependant on time, temperature, solution concentration and the presence of other species able to-stabilize the compounds, thereby preventing or slowing further ligand exchange. Preferably z″ is from 1-5, more preferably from 1-3.

The foregoing class of non-ionic Lewis acids is also suitable for use in the present invention in the absence of aluminumoxy species. Such compounds accordingly are adducts corresponding to the formula:
Ar^{f}_{z}Al₂Q¹₆₋₂

where Ar^{f}, Q¹ and z are as previously defined.

Preferred non-ionic Lewis acids for use herein are those of the foregoing formula (I) wherein:

Q¹ independently each occurrence is selected from C₁₋₂₀ alkyl;

Ar^{f} is a fluorinated aromatic hydrocarbyl moiety of from 6 to 30 carbon atoms;

z is a number greater than 0 and less than 6, and the moiety: Ar^{f}_{z}Al₂Q¹_{6-z} is an adduct of tri(fluoroarylaluminum) with from a sub-stoichiometric to a super-stoichiometric amount of a trialkylaluminum having from 1 to 20 carbons in each alkyl group.

The foregoing mixtures of non-ionic Lewis acids and adducts may be readily prepared by reaction of a fluoroarylborane, preferably tris(pentafluorophenyl)borane with one or more trihydrocarbylaluminum, dihydrocarbylaluminumhydrocarbyloxides, or dihydrocarbylaluminum(dihydrocarbyl)amide compounds having up to 20 atoms other than hydrogen in each hydrocarbyl, hydrocarbyloxy or dihydrocarbylamide group, or a mixture thereof with one or more aluminoxy compounds (such as an alumoxane) substantially according to the conditions disclosed in U.S. Pat. No. 5,602,269. Generally the various reagents are merely contacted in a hydrocarbon liquid, or preferably neat, at a temperature from 0 to 75° C., for a period from one minute to 10 days. Examples of specific non-ionic aluminum Lewis acid reagents for use herein, reagent ratios, and resulting products are illustrated as follows:
Ar^{f}₃Al+Q¹₃Al→Ar^{f}₃Al₂Q¹₃(Ar^{f}₃Al—AlQ¹₃)
Ar^{f}₃B+2Q¹₃Al→Ar^{f}₃Al₂Q¹₃+BQ¹₃ (Ar^{f}₃Al.AlQ¹₃)
Ar^{f}₃Al+2Q¹₃Al→3 Ar^{f}AlQ¹₂→³/₂Ar^{f}₂Al₂Q¹₄ (Ar^{f}₃Al.2AlQ¹₃)
Ar^{f}₃Al+5Q¹₃Al→3Ar^{f}Al₂Q¹₅ (Ar^{f}₃Al.5AlQ¹₃)
Ar^{f}₃Al+10Q¹₃Al→3Ar^{f}Al₂Q¹₅+5 Q¹₃Al (Ar^{f}₃Al.10 AlQ¹₃)
2Ar^{f}₃B+3Q¹₃Al→3Ar^{f}AlQ¹+2 BQ¹₃→³/₂ Ar^{f}₄Al₂Q¹₂ (Ar^{f}₃Al^{f}₃Al.¹/₂AlQ¹₃)
5Ar^{f}₃B+6Q¹₃Al→5BQ¹₃+Ar^{f}₅Al₂Q¹(Ar^{f}₃Al.¹/₅AlQ¹₃)

Preferred non-ionic Lewis acids for use according to the present invention are those wherein Ar^{f} is pentafluorophenyl, and Q¹ is C₁₋₄ alkyl. Most preferred non-ionic Lewis acids used according to the present invention are those wherein Ar is pentafluorophenyl, and Q¹ each occurrence is methyl, isopropyl or isobutyl. A most highly preferred non-ionic Lewis acid is tris(pentafluorophenyl)aluminum or tris(pentafluorophenyl)boron.

The non-protic Lewis base modifier, component 4), used in the supported catalyst of the-present invention, preferably is a fully C₁₋₂₀ hydrocarbyl- or a C₁₋₂₀ halohydrocarbyl-substituted compound of nitrogen, phosphorus, oxygen or sulfur, most preferably a tri(C₁₋₆hydrocarbyl)-substituted nitrogen or phosphorus compound. Optionally, two or more of the substituent groups may together form a divalent ligand group, thereby forming a ring system.

Preferred non-protic Lewis bases employed in the present invention have the general formula R_{w}A where A is a heteroatom selected from nitrogen, phosphorus, oxygen or sulfur and w is the standard valence of the heteroatom, that is, 2 for oxygen and sulfur and 3 for nitrogen and phosphorus and R is a linear, branched or cyclic hydrocarbyl radical of 1 to 20 carbon atoms, and optionally two R groups together may form a divalent derivative thereof The hydrocarbyl groups can be alkyl, cycloalkyl, aryl, alkaryl, arylalkyl or alkenyl, or two groups together may be an alkanediyl group. Each substituent can be a different moiety. Most highly preferred non-protic Lewis bases are diethylether, diisopropylether, triethylamine, diethylphenylamine, triphenylphosphine, tributylphosphine, quinuclidine, methyl pyrrolidine, methyl piperidine, tetrahydrofuran, tetrahydrothiophene and pyridine.

The skilled artisan will appreciate that the foregoing disclosures of preferred, more preferred and most preferred embodiments of respective components of the supported catalyst are intended to constitute full disclosure of all possible combinations of the various embodiments of components as well, such as the specific combination of each of the preferred, more preferred and most preferred embodiments of each of the components 1) to 4).

In the actual preparation of the present supported catalyst composition, the catalyst components may be combined in any order. In a preferred embodiment of the present invention, the non-ionic Lewis acid activator and the non-protic Lewis base modifier are combined in a separate step as a single product and then this product and the remainder of the catalyst components are added in any order.

The molar ratio of non-ionic Lewis acid: non-protic Lewis base used in the practice of the invention may vary from 1:10 to 10:1. Preferably the two components are used in an equimolar proportion. Generally, the ratio of moles of activator compound to moles of transition metal complex in the supported catalyst is from 0.5:1 to 2:1, preferably from 0.5:1 to 1.5:1 and most preferably from 0.75:1 to 1.25:1. At too low ratios the supported catalyst will not be very active, whereas at too high ratios the catalyst cost becomes excessive due to the relatively large quantities of activator compound utilized. The quantity of transition metal complex which generally becomes adsorbed on the inorganic oxide matrix in the resulting supported catalyst is preferably from 0.0005 to 20 mmol/g, more preferably from 0.001 to 10 mmol/g.

The support of the present invention desirably comprises from 0.001 to 10 mmol of the transition metal complex per gram of inorganic oxide, preferably from 0.01 to 1 mmol/g. At too high amounts of transition metal complex, the support becomes expensive. At too low amounts the catalyst efficiency of the resulting supported catalyst becomes unacceptable.

The support of the present invention can be stored or shipped under inert conditions as the solid, isolated, supported catalyst. It may also be slurried in an inert diluent, such as alkane or aromatic hydrocarbons. It may be used to generate the supported catalyst of the present invention by contacting with a suitable transition metal compound optionally in the presence of a liquid diluent.

In a further preferred embodiment of the invention, the support is a physically treated and trialkylaluminum-functionalized silica, and the non-protic Lewis base is added thereto before the addition of either the non-ionic Lewis acid activator or the transition metal complex. The components of the catalyst system can be combined in a suitable liquid diluent, such as an aliphatic or aromatic hydrocarbon to form a slurry. The temperature, pressure, and contact time for the preparation are not critical, but generally vary from −20° C. to 150° C., pressures from 1 Pa to 10,000 MPa, more preferably at atmospheric pressure (100 kPa), and for contact times of from 5 minutes to 48 hours. Usually the slurry is agitated. After this treatment the solids are typically separated from the diluent.

The supported catalysts of the present invention may be used in addition polymerization processes wherein one or more addition polymerizable monomers are contacted with the supported catalyst of the invention under addition polymerization conditions.

Suitable addition polymerizable monomers include ethylenically unsaturated monomers, acetylenic compounds, conjugated or non-conjugated dienes, and polyenes. Preferred monomers include olefins, for examples alpha-olefins having from 2 to 20,000, preferably from 2 to 20, more preferably from 2 to 8 carbon atoms and combinations of two or more of such alpha-olefins. Particularly suitable alpha-olefins include, for example, ethylene, propylene, 1-butene, 1-pentene, 4-methylpentene-1,1-hexene, 1-heptene, 1-octene, 1-nonene, 1-decene, 1-undecene, 1-dodecene, 1-tridecene, 1-tetradecene, 1-pentadecene, or combinations thereof, as we as long chain vinyl terminated oligomeric or polymeric reaction products formed during the polymerization, and C₁₀₋₃₀ α-olefins specifically added to the reaction mixture in order to produce relatively long chain branches in the resulting polymers. Preferably, the alpha-olefins are ethylene, propene, 1-butene, 4-methyl-pentene-1,1-hexene, 1-octene, and combinations of ethylene and/or propene with one or more of such other alpha-olefins. Other preferred monomers include styrene, halo- or alkyl substituted styrenes, tetrafluoroethylene, vinylcyclobutene, 1,4-hexadiene, dicyclopentadiene, butadiene, isoprene, ethylidene norbornene, and I,7-octadiene. Mixtures of the above-mentioned monomers may also be employed.

The supported catalyst can be advantageously employed in a high pressure, solution, slurry or gas phase polymerization process. A high pressure process is usually carried out at temperatures from 100 to 400° C. and at pressures above 500 bar. A slurry process typically uses an inert hydrocarbon diluent and temperatures of from 0° C. up to a temperature just below the temperature at which the resulting polymer becomes substantially soluble in the inert polymerization medium. Preferred temperatures are from 40° C. to 115° C. The solution process s carried out at temperatures from the temperature at which the resulting polymer is soluble in an inert solvent up to 275° C., preferably at temperatures of from 130° C. to 260° C., more preferably from 150° C. to 240° C. Preferred inert solvents are C₁₋₂₀ hydrocarbons and preferably C₅₋₁₀ aliphalic hydrocarbons, including mixtures thereof. The solution and slurry processes are usually carried out at pressures between 100 kPa to 10 MPa. Typical operating conditions for gas phase polymerizations are from 20 to 100° C., more preferably from 40 to 80° C. In gas phase processes the pressure is typically from 10 kPa to 10 MPa. Condensed monomer or diluent may be injected into the reactor to assist in heat removal by means of latent heat of vaporization.

Preferably for use in gas phase polymerization processes, the support has a median particle diameter from 20 to 200 pm, more preferably from 30 pm to 150 pm, and most preferably from 50 pm to 100 pm. Preferably for use in slurry polymerization processes, the support has a median particle diameter from 1 pm to 200 pm, more preferably from 5 pm to 100 pm, and most preferably from 20 pm to 80 pm. Preferably for use in solution or high pressure polymerization processes, the support has a median particle diameter from 1 to 40 pm, more preferably from 1 pm to 30 pm, and most preferably from 1 pm to 20 pm.

In the polymerization process of the present invention, scavengers may be used which serve to protect the supported catalyst from catalyst poisons such as water, oxygen, and polar compounds. These scavengers are generally used in varying amounts depending on the amounts of impurities. Preferred scavengers include the aforementioned organoaluminum compounds of the formula AlR₃ or alumoxanes.

In the present polymerization process, molecular weight control agents can also be used. Examples of such molecular weight control agents include hydrogen, trialkyl aluminum compounds or other known chain transfer agents. A particular benefit of the use of the present supported catalysts is the ability (depending on reaction conditions) to produce narrow molecular weight distribution olefin homopolymers and copolymers.

Having described the invention the following examples are provided as further illustration thereof and are not to be construed as limiting. Unless stated to the contrary all parts and percentages are expressed on a weight basis. The bulk density of the polymers produced was determined according to ASTM 1895. Unless otherwise stated, all manipulations were carried out in an inert atmosphere either in a nitrogen-filled glove box or under nitrogen using Schlenk techniques.

### EXAMPLES

The semi-batch polymenzation examples which follow were carried out in a 13 liter gas phase reactor having a four inch diameter, thirty inch long fluidization zone and an eight inch diameter, ten inch long velocity reduction zone which are connected by a transition section having tapered walls. Typical operating ranges are 40 to 100° C., 250 to 350 psig (1.7 to 2.4 MPa) total pressure and up to 8 hours reaction time. Ethylene, comonomer, hydrogen and nitrogen enter the bottom of the reactor where they pass through a gas distributor plate. The flow of the gas is 2 to 8 times the minimum particle fluidization velocity {Fluidization Engineering, 2nd Ed., D. Kunii and O. Levenspiel, 1991, Butterworth-Heinemann]. Most of the suspended solids disengage in the velocity reduction zone. The reactant gases exit the top of the velocity reduction zone and pass through a dust filter to remove any fines. The gases then pass through a gas booster pump.

The catalyst was prepared and loaded into a catalyst injector in an inert atmosphere glovebox. The injector was removed from the glovebox and inserted into the top of the reactor. The catalyst was then injected and the polymer was usually allowed to form for the desired reaction time. The total system pressure is kept constant during the reaction by regulating the flow of monomer into the reactor. The pressures of ethylene, comonomer and hydrogen reported refer to partial pressures. The polymer is allowed to accumulate in the reactor over the course of the reaction. Polymer is removed from the reactor to a recovery vessel containing an appropriate amount of an antioxidant package by opening a valve located at the bottom of the fluidization zone. The polymer recovery vessels kept at a lower pressure than the reactor. Upon completion of the reaction the reactor was emptied and the polymer powder was collected.

### Example 1

Catalyst/Support Preparation

15 grams of silica (Crosfield ES7O, available from Crosfield Company, Inc.) was thermally dehydrated at 500° C. for 5 hours in an inert stream of nitrogen. The silica was transferred into an inert atmosphere glovebox where it was treated with triethylaluminum (TEA). The silica was suspended in an amount of dry toluene followed by slow addition of 22.5 mmoles of TEA. The amount of TEA that was added corresponded to a hydroxyl/TEA ratio of 1/1.25 (1.5 mmoles TEA/g silica). The silica was then washed several times with toluene to remove any soluble aluminum containing components that may have resulted during the TEA treatment step.

An aliquot (150 μL of a 0.01 M solution (1.5 μmol) of quinuclidine in toluene was added to 0.05 grams of the pretreated silica which was prewetted with approximately 150 μL of toluene. An aliquot (75 μl) of a 0.01 M solution (0.75 μmol) of (t-butylamido)dimethyl(tetramethycycopentadienyl)titanium (II) 1,3-pentadiene in toulene was added to the suspended quinuclidine/silica. An aliquot (37.5 μL) of a 0.02 M solution (0.75 μmol) of tris(pentafluorophenyl)borane was added to the suspended metallocene/quinuclidine/slica. The volatiles were removed to give a free-flowing powder.

Polymerization

The catalyst described above was added to a semi-batch gas phase reactor which was under an ethylene pressure of 240 psig (1.7 Pa), a 1-butene pressure of 5.4 psig (40 kPa,) a hydrogen pressure of 1.3 psig (10 kPa) and a nitrogen pressure of 53 psig (370 kPa). The catalyst was injected at a reactor temperature of 69° C. 45.0 grams of polymer was recovered after 30 minutes reaction time.

### Examples 2-12

Following the procedure of Example 1, supported catalysts were prepared at varying ratios of transition metal complex (catalyst), non-ionic Lewis acid activator (cocatalyst) and non-protic Lewis base modifier (quinuclidine) as shown in Table 1 and then employed in the described polymerization procedure for the reaction times indicated to give the yields of polymer indicated. Efficiency is reported as Kg of polymer per gram of supported catalyst.

TABLE 1

| | μmol | | μmol | time | yield | Eff. |
|---|---|---|---|---|---|---|
| Example | quinuclidine | μmol catalyst | cocatalyst | (min) | (g) | Kg/g |
| 1 | 1.50 | 0.75 | 0.75 | 30 | 45.0 | 0.67 |
| 2 | 3.00 | 0.75 | 0.75 | 23.3 | 27.0 | 0.40 |
| 3 | 0.50 | 1.00 | 1.00 | 30 | 25.0 | 0.37 |
| 4 | 1.00 | 1.00 | 1.00 | 30 | 24.6 | 0.37 |
| 5 | 0.75 | 0.75 | 0.75 | 30 | 20.9 | 0.31 |
| 6 | 0.50 | 0.75 | 0.75 | 16.4 | 13.1 | 0.20 |
| 7 | 0.38 | 0.75 | 0.75 | 30 | 21.0 | 0.31 |
| 8 | 2.25 | 0.75 | 0.75 | 8.5 | 11.3 | 0.17 |
| 9 | 7.50 | 0.75 | 0.75 | 30 | 2.4 | 0.04 |
| 10 | 3.75 | 0.75 | 0.75 | 30 | 6.8 | 0.10 |
| 11 | 3.75 | 0.75 | 0.75 | 30 | 5.1 | 0.08 |
| 12 | 1.50 | 0.75 | 0.75 | 11 | 13.3 | 0.20 |

### Example 13

2 grams of silica (Crosfield ES70, available from Crosfield Company, Inc.) were thermally dehydrated at 500° C. for 4 hours in an inert stream of nitrogen. The silica was transferred into an inert atmosphere glovebox where it was treated with triethylaluminum (TEA). The silica was suspended in an amount of dry toluene followed by slow addition of 2.4 mmoles of TEA. The amount of TEA that was added corresponded to a hydroxyl/TEA ratio of 1/1 (1.2 mmoles TEA/g silica). The silica was then washed several times with toluene to remove any residual TEA or alumoxane that may have resulted during the TEA treatment step.

To 10.26 mL (1000 μmol) of a 0.0975 M solution of tris(pentafluorophenyl)borane was added 1 mL of diethylether. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described above which had already been prewetted with approximately 300 μl of dry toluene. An aliquot (75 μL) of a 0.01 M solution (0.75 μmol) of the tris(pentafluorophenyl)borane-diethylether adduct was then added to the suspended silica. The volatiles were removed to give a free-flowing powder.

Polymerization

The catalyst described above was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. A 3° C. exotherm was measured upon injection of the catalyst. The temperature increased from 75° C. to 77° C. throughout the course of the 30 minute run. After a total reaction time of 30 minutes, 23.2 grams of polymer were recovered.

### Example 14

To 10.26 mL (1.0 mmol) of a 0.0975 M solution of tris(pentafluorophenyl)borane was added 1 mL of pyridine. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in example 13 that had already been prewetted with approximately 300 μl of dry toluene. An aliquot (75 μL) of a 0.01 M solution (0.75 μmol) of the tris(pentafluorophenyl)borane-pyridine adduct was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. 2.5 grams of polymer were recovered after 30 minutes.

### Example 15

To 10.26 mL (1000 μmo) of a 0.0975 M solution of tris(pentafuorophenyl)borane was added 1 mL of tetrahydrothiophene. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in example 1 3 that had already been prewetted with about 300 μl of dry toluene. An aliquot (75 μL) of a 0.01 M solution (0.75 μmol) of the tris(pentafluorophenyl)borane-tetrahydrothiophene product was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. 13 grams of polymer were recovered after 30 minutes.

### Example 16

To 10.26 mL (1.0 mmol) of a 0.0975 M solution of tris(pentafluorophenyl)borane was added 1 mL of quinuclidine. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in example 13 that had already been prewetted with about 300 μl of dry toluene. An aliquot (75 μL) of a 0.01 M solution (0.75 μmol) of the tris(pentafluorophenyl)borane-quinuclidine product was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. 21 grams of polymer were recovered after 30 minutes.

### Example 17

To 10.26 mL (1.0 mmol) of a 0.0975 M solution of tris(pentafluorophenyl)borane was added 1 mL of (1 4-diazobicyclo(2,2,2-octane) (DABCO). Al of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in Example 13 that had already been prewetted with about 300 μl of dry toluene. An aliquot (75 μL) of a 0.01 M solution (0.75 μmol) of the tris(pentafluorophenyl)borane-DABCO product was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. A 7° C. exotherm occurred upon injection of the catalyst. After 4 minutes reaction time, 9 grams of polymer were recovered.

### Example 18

To 10.26 mL (1.0 mmol) of a 0.0975 M solution of tris(pentafuorophenyl)borane was added 1 mL of 1-methylpyrrolidine. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in example 13 that had already been prewetted with about 300 μl of dry toluene. An aliquot (75 μL) of a 0.01 M solution (0.75 μmol) of the tris(pentafluorophenyl)borane 1-methylpyrrolidine product was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. After 30 minutes reaction time, 6 grams of polymer were recovered.

### Example 19

To 10.26 mL (1.0 mmol) of a 0.0975 M solution of tris(pentafluoropheny)-borane was added 1 mL of 1-methylpiperidine. All of the volatiles were removed under vacuum at 25° C. An aliquot (75 μL) of a 0.01 M solution (0.75 μmol) of (t-butylamido)dimethyl(tetramethylcyclopentadienyl)titanium (II) 1,3-pentadiene in toluene was then added to 0.0375 grams of the pretreated silica described in Example 13 that had already been prewetted with about 300 μl of dry toluene. An aliquot (75 μL) of a 0.01 M solution (0.75 μmol) of the tris(pentafluorophenyl)borane-1-methylpiperdine was then added to the suspended silica. The volatiles were removed to give a free-flowing powder. The catalyst was added to a semi-batch gas phase reactor that was under an ethylene pressure of 240 psig (1.7 Pa), a 1-butene pressure of 5.4 psig (40 kPa), a hydrogen pressure of 1.3 psig (10 kPa) and a nitrogen pressure of 53 psig (370 kPa). The catalyst was injected at a reactor temperature of 72° C. After 30 minutes reaction time, 24 grams of polymer were recovered.

1. A supported catalyst composition comprising: 1) a support, 2) one or more transition metal complexes, 3) one or more non-ionic Lewis acid activators, and 4) one or more non-protic Lewis base modifiers, wherein the one or more non-ionic Lewis acid activators and the one or more non-protic Lewis base modifiers are combined in a separate step and combined with the remainder of the catalyst components as a separate product and wherein the one or more transition metal complexes contains at least one π-bonded anionic ligand group and a Group 4 metal.

2. The supported catalyst composition of claim 1 wherein:
the one or more non-ionic Lewis acid activators correspond to the formula:
[M¹ₙ(Y)ₖ]
wherein M¹ is boron or aluminum;
Y is an anionic ligand group; and
n and k are chosen to provide charge balance; and
the one or more non-protic Lewis base modifier has modifiers have the formula R_{w}A where A is a heteroatom selected from the group consisting of nitrogen, phosphorus, oxygen and sulfur and w is 2 for oxygen and sulfur and 3 for nitrogen and phosphorus, and R is a linear, branched or cyclic hydrocarbyl radical of 1 to 20 carbon atoms, and optionally two R groups together may form a divalent derivative.

3. (canceled)

4. The supported catalyst composition of claim 2, wherein the support is a thermally dehydrated inorganic oxide material and at least a portion of the hydroxyl groups have been functionalized by means of a functionaizing agent, to yield a level of non-functionalized hydroxyl groups of from 0.0001-10 mmol/g of the inorganic oxide material, as determined by Fourier Transform Infrared Spectroscopy.

5. The supported catalyst composition of claim 4 wherein the inorganic oxide support is silica that has been functionalized by reaction with an aluminum trialkyl.

6. The supported catalyst composition of claim 1, wherein the one or more non-ionic Lewis acid activators are tris(pentafluorophenyl)boron or tris(pentafluorophenyl)aluminum.

7. The supported catalyst composition of claim 1, wherein the one or more non-protic Lewis base modifiers are a tri-substituted amine or phosphine.

8. The supported catalyst composition of claim 7, wherein the one or more non-protic Lewis base modifiers are a trialkyl amine.

9. The supported catalyst composition of claim 1, wherein the one or more non-protic Lewis base modifiers are a cyclic compound containing a nitrogen, oxygen or sulfur atom.

10. The supported catalyst composition of claim 1, wherein the one or more non-protic Lewis base modifiers are diethylether, diisopropylether, triethylamine, diethylphenylamine, triphenylphosphine, quinuclidine, methyl pyrroidine, methyl piperidine, tetrahydrofuran, tetrahydrothiophene or pyridine.

11. (canceled)

12. The supported catalyst system of claim 1, wherein each π-bonded anionic ligand group is independently selected from the group consisting of cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, and decahydroanthracenyl groups, and C₁₋₁₀ hydrocarbyl-substituted derivatives thereof.

13. (canceled)

14. The method of claim 1, wherein the one or more non-ionic Lewis acid activators and the one or more non-protic Lewis base modifiers are combined prior to addition of the remaining components.

15. An addition polymerization process comprising contacting one or more addition polymerizable monomers with the supported catalyst composition of claim 1 under addition polymerization conditions.

16. An addition polymerization process comprising contacting one or more addition polymerizable monomers with the supported catalyst composition prepared by any of the method of claim 14 under addition polymerization conditions.

17. The addition polymerization process of claim 15 carried out under slurry or gas phase polymerization conditions.

18. The addition polymerization process of claim 16 carried out under slurry or gas phase polymerization conditions.
